(19) United States
(12) Patent Application Publication
(10) Pub. No.: US 2003/0170365 A1
(43) Pub. Date: Sep. 11, 2003

(54) Natural fruit-based dietary sweetener blend compositions

(76) Inventor: Chifu Huang, St. Louis, MO (US)

Correspondence Address: Chifu Huang, 169 Swigert Avenue, Lexington, KY, 40505, US

(21) Appl. No.: 10/092,313

(22) Filed: Mar. 6, 2002

(51) Int. Cl. A23L 1/236

(52) U.S. Cl. 426/548

(57) ABSTRACT

Fruit-based natural dietary sweetener blend compositions containing Lo Han Kuo (Momordica Grosvenori Swingle) fruit concentrate powder, isomalt, and fructo-oligosaccharide. Specifically, new and improved fruit-based natural dietary sweetener blend compositions include an improved Lo Han Kuo fruit concentrate powder (a lighter yellow powder that is 300 times sweeter than refined cane sugar and has no bitter aftertaste), isomalt, and fructo-oligosaccharide. Furthermore, such new and improved fruit-based natural dietary sweetener blend compositions provide a sweetness level in the range of 3 times to 10 times sweeter than refined cane sugar. The present invention also involves the use of the improved Lo Han Kuo fruit concentrate powder ingredient in combination with isomalt and fructo-oligosaccharide to eradicate undesired lingering aftertaste, so that the sweetener blend compositions no longer exhibit lingering aftertaste.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of Invention

The present invention relates generally to the field of sweetener blend compositions, and relates specifically to the field of natural sweetener blend compositions including Lo Han Kuo fruit concentrate powder, isomalt, and fructo-oligosaccharide as components.

2. Description of Prior Art

Over the past several years, there has been a growing concern of having too much sugar consumption in the human diet. It is a well establish fact that too much sugar consumption in the human diet can have negative heath effects, namely the development of diabetes, obesity, and other negative health issues. Therefore, a number of companies and individuals have developed “sugar substitutes” to address these concerns. Specifically, several companies, namely Monsanto and other pharmaceutical companies, have developed chemical compounds that taste sweet and are low in calories that can be used as “sugar substitutes” in both food and beverage products. These sweetening chemical compounds form the basis of synthetic sweetener blend products and are promoted as “sugar substitutes” and are considered low in calories. Many of these low calorie sweetener blends contain synthetic sweetening ingredients such as saccharine, aspartame, cyclamate, dipeptides, and Acesulfame K. These low calorie synthetic sweetener blends are prepared by diluting the intense synthetic sweetener ingredient with dextrose, corn syrup solids, sucrose, polyglucose, and fructo-oligosaccharides. Many of these synthetic sweetener blends are marketed under the name of Sweet-n-Low, Equal, NutraSweet, and many other various private labels.

However, there has been rising concern over the use of artificial chemicals in place of natural sugar. Therefore, the focus in the sweetener industry has been shifted to finding more refined ingredients and natural ingredients to use as “sugar substitutes”. Several companies have developed special sweetener blend compositions using refined sweetening ingredients such as dextrose, refined fructose, refined polysaccharides, sucralose, and brown sugar as the basis for “sugar substitute” products. For example and not limiting, McNeil Specialty Products Company have developed a sucralose-based sweetener blend composition that is marketed by under the brand name of Splenda, which is promoted as a “sugar” alternative to refined cane sugar.

In addition, some companies that focus on primarily promoting all-natural products have developed “sugar substitute” blends that only contain all-natural ingredients and contain no synthetic additives or man-made chemicals. These all-natural “sugar substitutes” contain only natural ingredients such as honey, fructans, fructose, molasses, inulin, levan, polysaccharides, fructo-oligosaccharides, isomalto, maple syrup products, hydrolyzed whole grain (sorghum, rice, and barley) products, cane juice, Lo Han Kuo fruit concentrate, apple concentrate, grape concentrate, fruit concentrate powders, liquid fruit concentrates, and many other fruit-based powders. By way of example and not limitation, the sweeteners that contain Lo Han Kuo fruit are FrutSweet (patent pending) distributed by Western Commerce Corporation and claims to be 20 times or 25 times sweeter than refined sugar and is marketed to manufacturers, and SlimSweet distributed by Trimedica, Inc. and claims to be 15 times sweeter than refined sugar and is marketed to consumers. It is important to note that all of the sweetener blend compositions containing Lo Han Kuo fruit only contain the ingredients of Lo Han Kuo fruit concentrate that is 250 times sweeter than refined sugar, fructose, and silicon dioxide. All of the sweetener blend compositions that contain Lo Han Kuo fruit have a bitter aftertaste and do not use any fructo-oligosaccharide and isomalt in combination as an ingredient, a bulking agent, or a base.

This need for “sugar substitutes” has been the factor for many companies and individuals to pursue patenting various sweetener blend compositions that are promoted as alternatives to sugar and as improvements of past sweetener blend compositions. Namely, by way of exemplification and not limitation in this regard, reference is had herein, for instance, to U.S. Pat. No. 6,274,707 entitled “Protein sweetener”,which issued on Aug. 14, 2001. In accordance with the teachings of U.S. Pat. No. 6,274,707, there is provided a sweetener blend composition that are sweet proteins that are variants of Brazzein, and nucleotide sequences capable of expressing them and furthermore, this patent provides an improved protein sweetener. This aforementioned example shows a sweetener blend composition that is a natural sweetener that can be used as a natural sugar substitute and is an improvement of prior protein sweeteners.

Another example, by way of exemplification and not limitation in this regard, reference is had herein, for instance, to U.S. Pat. No. 5,510,123 entitled “Food Sweetener Composition and Process”,which issued on Apr. 23, 1996. In accordance with the teachings of U.S. Pat. No. 5,510,123, there is provided food sweetener compositions containing aspartame and sugar acids, which eradicates the undesired lingering aftertaste of aspartame without contributing to viscosity or pulp volume. This aforedescribed example shows new and improved aspartame-based sweetener blend compositions that provide better sweetener blend compositions that removed unpleasant and unwanted aftertaste without adding unwanted viscosity or pulp volume; hence, making the product more desirable to both manufacturers and consumers.

Another example, by way of exemplification and not limitation in this regard, reference is had herein, for instance, to U.S. Pat. No. 6,180,155, entitled “Sweetener Having an Improved Sucrose-like Taste and Process For the Preparation Thereof and Use Thereof”, which issued on Jan. 30, 2001. In accordance with the teachings of U.S. Pat. No. 6,180,155, there is provided a sweetener having an improved sucrose-like taste, which contains at least one synthetic sweetener or a mixture of different artificial sweeteners and at least one deoxysugar, in particular rhamnose or fucose. The aforementioned example shows a sweetener blend composition that is a new and improved sweetener blend composition that makes the synthetic sweetener blend composition more like refined table sugar, which is preferred by the consumer.

The aforedescribed patents are examples of sweetener blend compositions that have provided new and improved sweetener blend compositions. Likewise, a need has arisen in the prior art in the sweetener blend composition industry to also take advantage of the improved blending of different natural ingredients as well as the technological advances in ingredient flavor quality improvements, namely an improved ingredient of Lo Han Kuo fruit concentrate powder that contains no bitter taste and is 300 times sweeter than refined cane sugar to provide new and improved fruit-based natural dietary sweetener blend compositions for consumers and manufacturers that contain all-natural ingredients. Furthermore, it is noted again that the preceding prior art references are merely illustrative or representative of a substantial number of references disclosing similar products for use either sugar substitute blends, but not in the composition of Lo Han Kuo concentrate powder (300 times sweeter than refined cane sugar), isomalt, and fructo-oligosaccharide. Our present invention provides new and improved fruit-based natural dietary sweetener blend compositions.

It is important to note that there are many disadvantages to the sweetener blend compositions of the prior art. The first disadvantage to the prior sweetener blend compositions is that there is an unpleasant aftertaste and a distinct flavor that make the prior sweetener blend compositions undesirable to use in place of sugar or to use as an ingredient substitute in some food and beverage applications. This aftertaste, which is characterized as a bitter, or a metallic flavor, continues or lingers for a period of time in excess of five seconds after the sweetener blend composition has exited the oral cavity. Specifically, sweetener blend compositions that contain Lo Han Kuo fruit have a strong bitter aftertaste and unpleasant flavor that is unfavorable to both consumers and manufacturers.

The second disadvantage to the prior art is that many of the ingredients of the sweetener blend compositions do not blend well together and often separate over a short period of time. These ingredients separate within the packaging with general use by the customer. For exemplification and not limitations, the sweetener blend compositions that contain Lo Han Kuo fruit concentrate powder blended with fructose and silicon dioxide separates easily from the Lo Han Kuo fruit concentrate powder. Furthermore, the Lo Han Kuo fruit concentrate powder settles at the bottom of the container, which weakens the sweetness level for the overall sweetener blend composition and makes the sweetness level inconsistent for each individual serving size. In addition, the separation of the ingredients in the prior art makes the physical appearance of the sweetener blend composition unattractive, which makes the sweetener blend composition problematic to market to both consumers and manufacturers.

The third disadvantage to the prior art is that some of the sweetening ingredients decompose under certain food processing conditions and lose their sweetness when heated. Hence, the sweetener blend composition is rendered useless in cooking, baking, and other heating applications.

The fourth disadvantage to the prior art is that the sweetener blend compositions containing Lo Han Kuo fruit are too concentrated for the consumer and have higher sweetness levels in comparison to the sweetness level of refined cane sugar. Hence, making the prior sweetener blend compositions very confusing and difficult for the consumer to use. The consumer cannot measure the product like refined cane sugar. The consumer has to make a measurement conversion to the manufacturer's designated measurements in order to get the proper equivalent to standard refined cane sugar measurements. The consumers cannot freely use the product properly without the manufacturer's designated measurement standards. There are no teaspoon-to-teaspoon refined cane sugar equivalent measurements for sweetener blend compositions containing Lo Han Kuo fruit. Specifically, the sweetener blend compositions that contain Lo Han Kuo fruit come only in three sweetness levels of 15 times, 20 times, and 25 times sweeter than refined cane sugar. Therefore, the consumer must convert these concentrated sweetener blend compositions containing Lo Han Kuo fruit to a particular measurement in order to measure like refined cane sugar. The consumer has to use a special measurement instead of the measurement that the consumer is accustomed to using. These higher concentrated levels make it difficult for the consumer to easily cook, bake, mix, and use daily with food and beverage products. In the prior art, there is a tendency for the consumer to add too much of the sweetener blend composition containing Lo Han Kuo fruit to food and beverage products, since the consumer is accustomed to the measurements of adding refined cane sugar, which is less sweeter than the concentrated sweetener blend compositions, to food and beverage products at a certain usage level. Therefore, it is very easy for the consumer to over use and over sweeten a product that they want to sweeten. Once the product is over sweetened, the consumer finds it very difficult to remove this extra sweetness from the product that they try to sweeten by adding the highly concentrated sweetener blend composition containing Lo Han Kuo fruit.

The fifth disadvantage to the prior art is that the sweetener blend compositions contain ingredients that are undesirable to some consumers. For example and not limiting, the prior sweetener blend compositions containing Lo Han Kuo fruit contained one such undesirable ingredient, silicon dioxide, which is a known anti-caking agent. Many consumers prefer not to have this particular chemical ingredient in their all-natural sweetener products.

The sixth disadvantage to the prior art is that there is not a variety of sweetener blend compositions that contain Lo Han Kuo fruit with many other natural ingredients. Namely, the prior sweetener blends only contain the Lo Han Kuo fruit with just fructose and silicon dioxide. Hence, the consumers and manufacturers do not have very many choices for sweetener blend compositions that contain Lo Han Kuo fruit.

The seventh disadvantage to the prior art is that the coloring of the sweetener blend compositions containing Lo Han Kuo fruit is either too yellow or too brown in coloring. This discoloring is unpopular with consumers since the consumer is used to the white coloring of refined cane sugar. White is perceived as pure and the yellowish brown tinting of the sweetener blend compositions containing Lo Han Kuo fruit make the consumer think that the product is tainted and not pure. Moreover, the uneven distribution of ingredients creates an irregular coloration in the sweetener blend composition, which further contributes to the consumer's perception of an impure product.

The eighth disadvantage to the prior art is that there is a limited selection of sweetness levels for sweetener blend compositions containing Lo Han Kuo fruit. There are only three sweetness levels offered to the consumer, namely 15 times sweeter than refined cane sugar, 20 times sweeter than refined cane sugar, and 25 times sweeter than refined cane sugar. Most consumers have different taste and sweetness level preferences. In addition, consumers prefer to have a sweetener blend composition that is closer in the range of the sweetness level of refined cane sugar.

The ninth disadvantage to the prior art is that none of the sweetener blend compositions containing Lo Han Kuo fruit contain fructo-oligosaccharide, and isomalt as an ingredient or a bulking agent.

The aforedescribed disadvantages in the prior art have further increased the need for new and improved fruit-based natural dietary sweetener blend compositions. Furthermore, very health-conscious consumers have further fueled the need and the desire for all-natural sweetener blend compositions. A need has arisen in the prior art for new and improved fruit-based natural dietary sweetener blend compositions that have a pleasant sweet flavor and do not have an unpleasant bitter aftertaste. Therefore, a need has become self-evident in the practices of the prior art for new and improved fruit-based natural dietary sweetener blend compositions that contain a higher-grade, improved Lo Han Kuo fruit concentrate powder that is 300 times sweeter than refined cane sugar and does not have a bitter aftertaste and is lighter yellow in coloring. Likewise, a great need still exists for new and improved fruit-based natural dietary sweetener blend compositions, which are balanced by a total replacement of sugar by natural “sugar substitute” ingredients while still offering the taste and the physical properties of refined cane sugar. In addition, a need exists for new and improved fruit-based natural dietary sweetener blend compositions that are powder formulas and can be used and measured more in close proportion to refined cane sugar. Moreover, a need has arisen in the prior art for new and improved fruit-based natural dietary sweetener blend compositions that have a sweetness level range from 3 times sweeter than refined cane sugar to 10 times sweeter than refined cane sugar. Even more so, the practices of the prior art show a further need for new and improved fruit-based natural dietary sweetener blend compositions that contain an improved Lo Han Kuo fruit concentrate powder (300 times sweeter than refined cane sugar), isomalt, and fructo-oligosaccharide.

Therefore, all of these combined needs evidenced in the prior art in the sweetener blend composition industry call for new and improved fruit-based natural dietary sweetener blend compositions that are powder formulas that contain an improved Lo Han Kuo fruit concentrate powder (300 times sweeter than refined cane sugar), isomalt, and fructo-oligosaccharide and that such new and improved fruit-based natural dietary sweetener blend compositions come in a sweetness level range of 3 to 10 times sweeter than refined cane sugar and also the sweetener blend compositions look and taste more like refined cane sugar and do not contain a bitter after-taste.

The needed new and improved fruit-based natural dietary sweetener blend compositions, which have been evidenced in the prior art, have a number of characteristics. The first characteristic of such new and improved fruit-based natural dietary sweetener blend compositions contain an improved Lo Han Kuo fruit concentrate powder (300 times sweeter than refined cane sugar), isomalt, and fructo-oligosaccharide and such new and improved sweetener blend compositions have a sweetness level range of 3 times sweeter than refined cane sugar to 10 times sweeter than refined cane sugar.

The second characteristic of such new and improved fruit-based natural dietary sweetener blend compositions is that the fruit-based natural dietary sweetener blend compositions do not leave an after-taste or unpleasant bitter flavor. Furthermore, such new and improved fruit-based natural dietary sweetener blend compositions should have a pleasant sweet flavor. Therefore, the fruit-based natural dietary sweetener blend compositions contain an improved Lo Han Kuo fruit concentrate powder that is 300 times sweeter than refined cane sugar and does not contain any bitter after-taste.

The third characteristic of such new and improved fruit-based natural dietary sweetener blend compositions is that the sweetener blend compositions do not contain unwanted chemical anti-caking agents, namely silicon dioxide.

The fourth characteristic of such new and improved fruit-based natural dietary sweetener blend compositions is that the sweetener blend compositions' sweetness levels are in a wide range for the consumer. Hence, the sweetness concentrated level choices of such new and improved fruit-based natural dietary sweetener blend compositions are in a range of 3 times sweetener than refined cane sugar to 10 times sweetener than refined cane sugar.

The fifth characteristic of such new and improved fruit-based natural dietary sweetener blend compositions is that the sweetener blend compositions do not break down under cooking, baking, and other heating applications and maintains its sweetness. Furthermore, the fruit-based natural dietary sweetener blend compositions' powdered ingredients stay blended together and maintain its consistent sweetness level per each individual serving. In addition, the sweetener blend compositions are lighter in coloring preferably white and white with light yellow highlights and are not a brown or dark yellow coloring with white highlights.

The sixth characteristic of such new and improved fruit-based natural dietary sweetener blend compositions is that the sweetener blend compositions dissolve easily in water and other liquids, namely alcohol.

There are many benefits of such new and improved fruit-based natural dietary sweetener blend compositions. One such benefit is that such new and improved fruit-based natural dietary sweetener blend compositions provide a more convenient and easier to use powder formula for the customer to more easily measure and use like refined cane sugar. Yet another such benefit is that such new and improved fruit-based natural dietary sweetener blend compositions provide the customer more variety of sweetness concentration levels that are not being previously offered to consumers, namely a range of 3 times to 10 times sweeter than refined cane sugar. Another such benefit is that such new and improved fruit-based natural dietary sweetener blend compositions are more marketable to customers since they look, taste, and feel more like refined cane sugar. Another such benefit is that such new and improved fruit-based natural dietary sweetener blend compositions taste more closely to refined cane sugar and do not leave an unpleasant aftertaste and do not have a bitter flavor. Yet another benefit is that such new improved fruit-based natural dietary sweetener blend compositions contain ingredients (e.g. Lo Han Kuo fruit concentrate powder that is 300 times sweeter than refined cane sugar, fructo-oligosaccharide, and isomalt. Yet still another benefit is that such new and improved fruit-based natural dietary sweetener blend compositions contain all-natural ingredients and do not contain any artificial, synthetic ingredients. Another benefit is that such new and improved fruit-based natural dietary sweetener blend compositions contain no sugar, are low in calories, and contain no fat. Yet still another benefit is that such new and improved fruit-based natural dietary sweetener blend compositions do not lose their sweetness during heating applications. Therefore, such new and improved fruit-based natural dietary sweetener blend compositions are ideal for cooking, baking, mixing, and generally adding to any food and beverage applications for a sweetening effect, Another such benefit is that such new and improved fruit-based natural dietary sweetener blend compositions that contain fructo-oligosaccharide and isomalt that is the bulking agent. Yet still another such benefit is that such new and improved fruit-based natural dietary sweetener blend compositions comprise all-natural ingredients. Another such benefit is that such new and improved fruit-based natural dietary sweetener blend compositions include the ingredients of fructo-oligosaccharide and isomalt, which promotes good health in the intestinal tract.

The present invention provides sweetener blend compositions that have all of the aforedescribed characteristics of such new and fruit-based natural dietary sweetener blend compositions and the present invention provides all the benefits as aforedescribed for such new and improved fruit-based natural dietary sweetener blend compositions.

### SUMMARY OF THE INVENTION

The present invention involves fruit-based natural dietary sweetener blend compositions containing Lo Han Kuo fruit concentrate powder, isomalt, and fructo-oligosaccharide. Specifically, new and improved fruit-based natural dietary sweetener blend compositions that comprise an improved Lo Han Kuo fruit concentrate powder (a lighter yellow powder that is 300 times sweeter than refined cane sugar and has no bitter aftertaste), isomalt, and fructo-oligosaccharide. Furthermore, such new and fruit-based natural dietary sweetener blend compositions provide a sweetness level in a range of 3 times to 10 times sweeter than refined cane sugar.

It is an object of the present invention to provide new and improved fruit-based natural dietary sweetener blend compositions.

It is still another object of the present invention to provide new and improved fruit-based natural dietary sweetener blend compositions containing an improved Lo Han Kuo fruit concentrate powder (300 times sweeter than refined cane sugar), isomalt, and fructo-oligosaccharide, and such new and improved fruit-based natural dietary sweetener blend compositions that have a sweetness level range of 3 times sweeter than refined cane sugar to 10 times sweeter than refined cane sugar.

It is still yet another object of the present invention to provide new and improved fruit-based natural dietary sweetener blend compositions that do not contain unwanted chemical anti-caking agents, namely silicon dioxide.

It is still yet another object of the present invention to provide new and improved fruit-based natural dietary sweetener blend compositions that have sweetness levels that are not too concentrated for the customers, namely sweetness concentration levels in a wide range of 3 times sweetener than refined cane sugar to 10 times sweetener than refined cane sugar.

It is still yet another object of the present invention to provide new and improved Lo Han Kuo fruit-based natural sweetener blend compositions that do not break down under cooking, baking, and other heating applications and maintain their sweetness.

It is another object of the present invention to provide new and improved fruit-based natural dietary sweetener blend compositions that the powdered ingredients stay blended together and maintain a consistent sweetness level per each individual serving.

It is yet another object of the present invention to provide new and improved fruit-based natural dietary sweetener blend compositions that are lighter in coloring preferably white and white with light yellow highlights and are not brown or dark yellow coloring with white highlights.

It is still another object of the present invention to provide new and improved fruit-based natural dietary sweetener blend compositions that dissolve easily in water and other liquids, namely alcohol.

It is yet another object of the present invention to provide new and improved fruit-based natural dietary sweetener blend compositions that are contain no bitter flavor and aftertaste.

In accordance with the present invention there is provided new and improved fruit-based natural dietary sweetener blend compositions comprising Lo Han Kuo fruit concentrate, isomalt, and fructo-oligosaccharide. The fruit-based natural dietary sweetener blend compositions of the present invention contain the Lo Han Kuo fruit concentrate that is an improved Lo Han Kuo fruit concentrate that is a light yellow colored powder that is 300 times sweeter than refined cane sugar and is derived from the fruit of the Momordica Grosvenori Swingle and has a Mogroside level of 80% or greater on a dry weight basis and has no bitter after-taste. The fruit-based natural dietary sweetener blend compositions of the present invention are in the form of crystalline, powder, particles, chips, flakes, spicules, and any combinations thereof. The fruit-based natural dietary sweetener blend compositions of the present invention have a sweetness level range of 3 times to 10 times sweeter than refined cane sugar and the sweetener blend compositions comprise Lo Han Kuo fruit concentrate, isomalt, and fructo-oligosaccharide and any combination thereof. The fruit-based natural dietary sweetener blend compositions of the present invention that has a sweetness level of 3 times sweeter than refined cane sugar comprises about 0.15% to about 0.19% Lo Han Kuo fruit concentrate, about 95% isomalt, and about 4.81% to about 4.85% fructo-oligosaccharide on a dry weight basis of the sweetener blend composition that has a sweetness level of 3 times sweeter than refined cane sugar. The fruit-based natural dietary sweetener blend composition of the present invention that has a sweetness level of 4 times sweeter than refined cane sugar comprises about 0.20% to about 0.24% Lo Han Kuo fruit concentrate, about 95% isomalt, and about 4.76% to about 4.80% fructo-oligosaccharide on a dry weight basis of the sweetener blend composition that has a sweetness level of 4 times sweeter than refined cane sugar. The fruit-based natural dietary sweetener blend composition of the present invention that has a sweetness level of 5 times sweeter than refined cane sugar comprises about 0.25% to about 0.29% Lo Han Kuo fruit concentrate, about 95% isomalt, and about 4.71% to about 4.75% fructo-oligosaccharide on a dry weight basis of the sweetener blend composition that has a sweetness level of 5 times sweeter than refined cane sugar. The fruit-based natural dietary sweetener blend composition of the present invention that has a sweetness level of 6 times sweeter than refined cane sugar comprises about 0.30% to about 0.34% Lo Han Kuo fruit concentrate, about 95% isomalt, and about 4.66% to about 4.70% fructo-oligosaccharide on a dry weight basis of the sweetener blend composition that has a sweetness level of 6 times sweeter than refined cane sugar. The fruit-based natural dietary sweetener blend composition of the present invention that has a sweetness level of 7 times sweeter than refined cane sugar comprises about 0.35% to about 0.39% Lo Han Kuo fruit concentrate, about 95% isomalt, and about 4.61% to about 4.65% fructo-oligosaccharide on a dry weight basis of the sweetener blend composition that has a sweetness level of 7 times sweeter than refined cane sugar. The fruit-based natural dietary sweetener blend composition of the present invention that has a sweetness level of 8 times sweeter than refined cane sugar comprises about 0.40% to about 0.44% Lo Han Kuo fruit concentrate, about 95% isomalt, and about 4.56% to about 4.60% fructo-oligosaccharide on a dry weight basis of the sweetener blend composition that has a sweetness level of 8 times sweeter than refined cane sugar. The fruit-based natural dietary sweetener blend composition of the present invention that has a sweetness level of 9 times sweeter than refined cane sugar comprises about 0.45% to about 0.49% Lo Han Kuo fruit concentrate, about 95% isomalt, and about 4.51% to about 4.55% fructo-oligosaccharide on a dry weight basis of the sweetener blend composition that has a sweetness level of 9 times sweeter than refined cane sugar. The fruit-based natural dietary sweetener blend composition of the present invention that has a sweetness level of 10 times sweeter than refined cane sugar comprises about 0.50% to about 0.55% Lo Han Kuo fruit concentrate, about 95% isomalt, and about 4.45% to about 4.50% fructo-oligosaccharide on a dry weight basis of the sweetener blend composition that has a sweetness level of 10 times sweeter than refined cane sugar. The fruit-based natural dietary sweetener blend compositions of the present invention are created by dry mixing the ingredients and the ingredients (e.g. Lo Han Kuo fruit concentrate, isomalt, and fructo-oligosaccharide) are commercially available. The fruit-based natural dietary sweetener blend compositions of the present invention are for the use of the sweetener blend compositions for a stand alone sweetener, a sweetening ingredient to be added to food and beverage products, and a sweetening agent and sweetening ingredient in any food, beverage, candy, jams, jelly, cake mixes, ice cream, puddings, chewing gum, gelatins, confectionery products, bakery goods, any novelty food and beverage products, and any dietary supplement products.

### DESCRIPTION OF THE PREFERRED EMBODIMENTS

Preferred embodiments of the present invention will be disclosed with the following description and examples of the present invention.

In a preferred embodiment, fruit-based natural dietary sweetener blend compositions contain an improved Lo Han Kuo fruit concentrate powder that is lighter yellow in coloring, is 300 times sweeter than refined cane sugar, contains 80% or greater level of Mogroside, and has no bitter aftertaste.

The best embodiment of this present invention is the combination of ingredients of Lo Han Kuo fruit concentrate powder (300 times sweeter than refined cane sugar), isomalt, and fructo-oligosaccharide to be used as a tabletop sweetener and to be used to sweeten other food and beverage products.

### EXAMPLES

The following Table 1 is illustrative of the following: Fruit-based natural dietary sweetener blend compositions comprising Lo Han Kuo fruit concentrate powder, fructo-oligosaccharide, and isomalt. The following examples of ingredient proportions are not to be construed as limiting, but merely demonstrate exemplary compositions of the present invention.

TABLE 1
Proportion of ingredients based on dry weight basis

| | % of each ingredient in the fruit-based natural | | |
|---|---|---|---|
| | dietary sweetener blend composition | | |
| | Lo Han Kuo fruit | | |
| Sweetness | concentrate powder | | |
| Concentration Levels | (300 times sweeter | | |
| (# of times sweeter than | than refined cane | | Fructo- |
| refined cane sugar) | sugar) | Isomalt | oligosaccharide |
| 3 times | 0.15%˜0.19% | 95% | 4.81%˜4.85% |
| 4 times | 0.20%˜0.24% | 95% | 4.76%˜4.80% |
| 5 times | 0.25%˜0.29% | 95% | 4.71%˜4.75% |
| 6 times | 0.30%˜0.34% | 95% | 4.66%˜4.70% |
| 7 times | 0.35%˜0.39% | 95% | 4.61%˜4.65% |
| 8 times | 0.40%˜0.44% | 95% | 4.56%˜4.60% |
| 9 times | 0.45%˜0.49% | 95% | 4.51%˜4.55% |
| 10 times | 0.50%˜0.55% | 95% | 4.45%˜4.50% |

The above description and examples are included to illustrate fruit-based natural dietary sweetener blend composition of the preferred embodiments and is not meant to limit the scope of the invention. The scope of the invention is to be limited only by the following claims. From the above discussion, many variations will be apparent to one skilled in the art that would yet be encompassed by the spirit and scope of the invention.

What is claimed is:

1. Fruit-based natural dietary sweetener blend compositions comprising: Lo Han Kuo fruit concentrate, isomalt, and fructo-oligosaccharide.

2. The fruit-based natural dietary sweetener blend compositions of claim 1, wherein said Lo Han Kuo fruit concentrate is an improved Lo Han Kuo fruit concentrate that is a light yellow colored powder that is 300 times sweeter than refined cane sugar.

3. The fruit-based natural dietary sweetener blend compositions of claim 2, wherein said Lo Han Kuo fruit concentrate is an improved Lo Han Kuo fruit concentrate that is derived from the fruit of the Momordica Grosvenori Swingle and has a Mogroside level of 80% or greater on a dry weight basis and has no bitter aftertaste.

4. The fruit-based natural dietary sweetener blend compositions of claim 1, wherein said isomalt is a crystalline form.

5. The fruit-based natural dietary sweetener blend compositions of claim 1, wherein said fructo-oligosaccharide is a powder fructo-oligosaccharide.

6. The fruit-based natural dietary sweetener blend compositions of claim 1, wherein said sweetener blend compositions are in the form of crystalline, powder, particles, chips, flakes, spicules, and any combinations thereof.

7. The fruit-based natural dietary sweetener blend compositions of claim 1, wherein said sweetener blend compositions have a sweetness level range of 3 times to 10 times sweeter than refined cane sugar and the sweetener blend compositions comprise Lo Han Kuo fruit concentrate, isomalt, and fructo-oligosaccharide and any combination thereof.

8. The fruit-based natural dietary sweetener blend compositions of claim 7, wherein said Lo Han Kuo fruit concentrate, isomalt, and fructo-oligosaccharide combination is about 0.15% to about 0.19% Lo Han Kuo fruit concentrate, about 95% isomalt, and about 4.81% to about 4.85% fructo-oligosaccharide on a dry weight basis of the sweetener blend composition that has the sweetness level of 3 times sweeter than refined cane sugar.

9. The fruit-based natural dietary sweetener blend compositions of claim 7, wherein said Lo Han Kuo fruit concentrate, isomalt, and fructo-oligosaccharide combination is about 0.20% to about 0.24% Lo Han Kuo fruit concentrate, about 95% isomalt, and about 4.76% to about 4.80% fructo-oligosaccharide on a dry weight basis of the sweetener blend composition that has the sweetness level of 4 times sweeter than refined cane sugar.

10. The fruit-based natural dietary sweetener blend compositions of claim 7, wherein said Lo Han Kuo fruit concentrate, isomalt, and fructo-oligosaccharide combination is about 0.25% to about 0.29% Lo Han Kuo fruit concentrate, about 95% isomalt, and about 4.71% to about 4.75% fructo-oligosaccharide on a dry weight basis of the sweetener blend composition that has the sweetness level of 5 times sweeter than refined cane sugar.

11. The fruit-based natural dietary sweetener blend compositions of claim 7, wherein said Lo Han Kuo fruit concentrate, isomalt, and fructo-oligosaccharide combination is about 0.30% to about 0.34% Lo Han Kuo fruit concentrate, about 95% isomalt, and about 4.66% to about 4.70% fructo-oligosaccharide on a dry weight basis of the sweetener blend composition that has the sweetness level of 6 times sweeter than refined cane sugar.

12. The fruit-based natural dietary sweetener blend compositions of claim 7, wherein said Lo Han Kuo fruit concentrate, isomalt, and fructo-oligosaccharide combination is about 0.35% to about 0.39% Lo Han Kuo fruit concentrate, about 95% isomalt, and about 4.61% to about 4.65% fructo-oligosaccharide on a dry weight basis of the sweetener blend composition that has the sweetness level of 7 times sweeter than refined cane sugar.

13. The fruit-based natural dietary sweetener blend compositions of claim 7, wherein said Lo Han Kuo fruit concentrate, isomalt, and fructo-oligosaccharide combination is about 0.40% to about 0.44% Lo Han Kuo fruit concentrate, about 95% isomalt, and about 4.56% to about 4.60% fructo-oligosaccharide on a dry weight basis of the sweetener blend composition that has the sweetness level of 8 times sweeter than refined cane sugar.

14. The fruit-based natural dietary sweetener blend compositions of claim 7, wherein said Lo Han Kuo fruit concentrate, isomalt, and fructo-oligosaccharide combination is about 0.45% to about 0.49% Lo Han Kuo fruit concentrate, about 95% isomalt, and about 4.51% to about 4.55% fructo-oligosaccharide on a dry weight basis of the sweetener blend composition that has the sweetness level of 9 times sweeter than refined cane sugar.

15. The fruit-based natural dietary sweetener blend compositions of claim 7, wherein said Lo Han Kuo fruit concentrate, isomalt, and fructo-oligosaccharide combination is about 0.50% to about 0.55% Lo Han Kuo fruit concentrate, about 95% isomalt, and about 4.45% to about 4.50% fructo-oligosaccharide on a dry weight basis of the sweetener blend composition that has the sweetness level of 10 times sweeter than refined cane sugar.

16. The fruit-based natural dietary sweetener blend compositions of claim 1, wherein said sweetener blend compositions are created by dry mixing the ingredients.

17. The fruit-based natural dietary sweetener blend compositions of claim 1, wherein said Lo Han Kuo fruit concentrate, isomalt, and fructo-oligosaccharide combination are commercially available.

18. The fruit-based natural dietary sweetener blend compositions of claim 1 are for the use of the sweetener blend compositions for a stand alone sweetener, a sweetening ingredient to be added to food and beverage products, and a sweetening agent and sweetening ingredient in any food, beverage, candy, jams, jelly, cake mixes, ice cream, puddings, chewing gum, gelatins, confectionery products, bakery goods, any novelty food and beverage products, and any dietary supplement products.
